(19) United States
(12) Patent Application Publication
(10) Pub. No.: US 2005/0104307 A1
(43) Pub. Date: May 19, 2005

(54) Material handling and shopping cart having a basket with a movable floor

(76) Inventor: Bruce Roseman, Mt. Kisco, NY (US)

Correspondence Address: LACKENBACH SIEGEL, LLP, LACKENBACH SIEGEL BUILDING, 1 CHASE ROAD, SCARSDALE, NY, 10583, US

(21) Appl. No.: 10/842,705

(22) Filed: May 10, 2004

Related U.S. Application Data
(60) Provisional application No. 60/469,193, filed on May 9, 2003.

(51) Int. Cl. B62D 3/00

(52) U.S. Cl. 280/33.997

(57) ABSTRACT

There is provided a shopping cart comprising a shopping cart basket with a vertically movable bottom wall. The vertical movement of the bottom wall is controlled by two pairs of springs. The first pair of springs has a first maximum load capacity, while the second pair of springs has a second maximum load capacity that is greater than the load capacity of the first pair of springs. The first pair of springs is connected to either the fore or aft corners of the bottom wall. The second pair of springs is connected to the side edges of the bottom wall. Low-friction, non-binding rollers are attached to the upper end of each spring and engage respective guide posts. Preferably, to avoid trapping items (or fingers) in the side walls of the shopping cart basket as the bottom wall lowers, the side walls of the shopping cart are initially collapsed and subsequently expand as the bottom wall lowers. In addition, the shopping cart preferably has a hand brake that prevents movement of the shopping cart unless held open by a user.

This application claims priority under 35 U.S.C. 119 of Provisional Patent Application No. 60/469,193 filed May 9, 2003.

### BACKGROUND OF THE INVENTION

1. Field of the Invention

This invention relates to carts that interfit with one another and are provided with features to facilitate the unloading thereof or otherwise assist in transferring purchased items deposited therein to a checkout counter.

2. Description of the Prior Art

Wheeled shopping carts are made available in grocery stores, department stores, home improvement stores, and the like for the convenience of a user when several items are collected by the user and taken to a check-out counter and/or to another vehicle. Thus, shopping carts of the general type being considered herein are well known. Invariably, shopping carts have a basket for holding user-selected items. Typically, the basket is mounted on a frame that has a handle and four caster-type wheels. In addition, shopping carts are usually nestable or stackable within one another to minimize the space required to store them.

However, many users find the depth of the shopping cart basket to be very inconvenient because reaching items placed on the floor of the shopping cart basket requires the user to reach or bend down, which movement may be painful or even impossible for the user. Thus, there is a need for shopping carts adapted to facilitate the unloading thereof without the user reaching or bending down into the shopping cart basket.

Previous shopping carts with telescoping or movable baskets were intended to increase the size of the shopping cart basket in proportion to the quantity and/or weight of the items in the shopping cart basket. For example, U.S. Pat. No. 2,958,536 to F. W. Young discloses a telescoping grocery cart having means for increasing the lading (i.e., loading) capacity thereof. For another example, U.S. Pat. No. 3,787,063 to Oliver discloses a shopping cart or the like having a movable bottom wall displaceable between retracted and extended positions in accordance with the magnitude of the weight supported by the bottom wall. In addition, U.S. Patent Application No. 2002/0135145 to Saccani discloses a shopping cart with the ability to move the entire basket in response to downward force. However, all these previous shopping carts provide that the bottom wall of the shopping cart basket is initially or permanently set at a typical depth from the top of the side walls. In other words, the previous shopping carts still required that a user reach or bend down to reach items disposed on the bottom wall.

U.S. Pat. No. 5,863,054 to Flores describes a grocery cart platform lift, which is a vertically movable horizontal shelf that is normally positioned near the upper rim of the basket of the cart. The shelf is spring biased so that as it becomes loaded with shopping items, the shelf tends to move downwardly within the shopping cart basket. As the shelf is unloaded, it tends to move upwardly, thereby making it easier to unload the shopping cart. However, the shelf is mounted only to the front wall of the shopping cart basket by a pair of telescoping tracks. Each track has a single spring biasing the shelf in the upward position.

Providing a shopping cart with a short vertically movable shelf biased in the upward direction by a single pair of springs is an incomplete solution to problem. If the springs are highly elastic to allow quick lowering of the bottom wall, the springs can be easily over-loaded such that a great many items must be removed from the shopping cart basket before the bottom wall will begin to rise. If the springs are only slightly elastic to allow quick rising of the bottom wall, the springs will inconveniently limit the available volume of the shopping cart basket unless several heavy items are loaded onto the bottom wall.

### SUMMARY

It is an object of the present invention to provide a shopping cart with a basket that reduces the need for a user to bend while loading and unloading the basket.

It is another object of the present invention to provide such a basket with a vertically movable bottom wall.

It is still another object of the present invention to provide such a vertically moveable bottom wall that is near the upper rim of the basket when unloaded and moves downward in response to the weight of the items placed upon it.

In light of the foregoing objects and other objective that will be disclosed in the course of the following disclosure of the present invention, there is provided a shopping cart comprising a shopping cart basket with a vertically movable bottom wall. The vertical movement of the bottom wall is controlled by two pairs of springs. The first pair of springs has a first maximum load capacity, while the second pair of springs has a second maximum load capacity that is greater than the load capacity of the first pair of springs. The first pair of springs is connected to either the fore or aft corners of the bottom wall. The second pair of springs is connected to the side edges of the bottom wall. Low-friction, non-binding rollers are attached to the upper end of each spring and engage respective guide posts. Preferably, to avoid trapping items (or fingers) in the side walls of the shopping cart basket as the bottom wall lowers, the side walls of the shopping cart are initially collapsed and subsequently expand as the bottom wall lowers. In addition, the shopping cart preferably has a hand brake that prevents movement of the shopping cart unless held open by a user.

### BRIEF DESCRIPTION OF THE FIGURES

FIG. 1 is a side view of a shopping cart according to the present invention showing the bottom wall of the basket in a retracted position;

FIG. 2 is a top view of the shopping cart of FIG. 1;

FIG. 3 is a side view of a first arrangement of the shopping cart of FIG. 1 nested with a second shopping cart of the same configuration;

FIG. 4 is a side view of a second arrangement of the shopping cart of FIG. 1 nested with a second shopping cart of the same configuration;

FIG. 5 is a partial side view of the shopping cart of FIG. 1 showing a preferred hand brake.

### DESCRIPTION OF THE INVENTION

As used herein, the term “moves vertically” includes movement in a direction normal to the ground and any other non-normal direction having a vertical component.

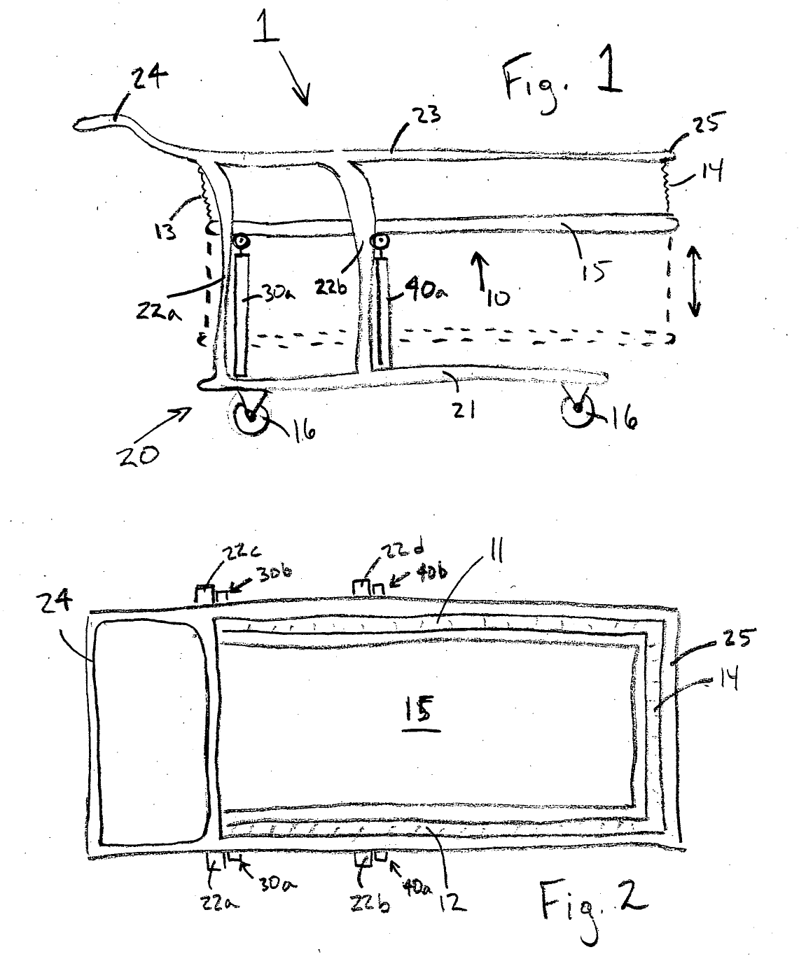

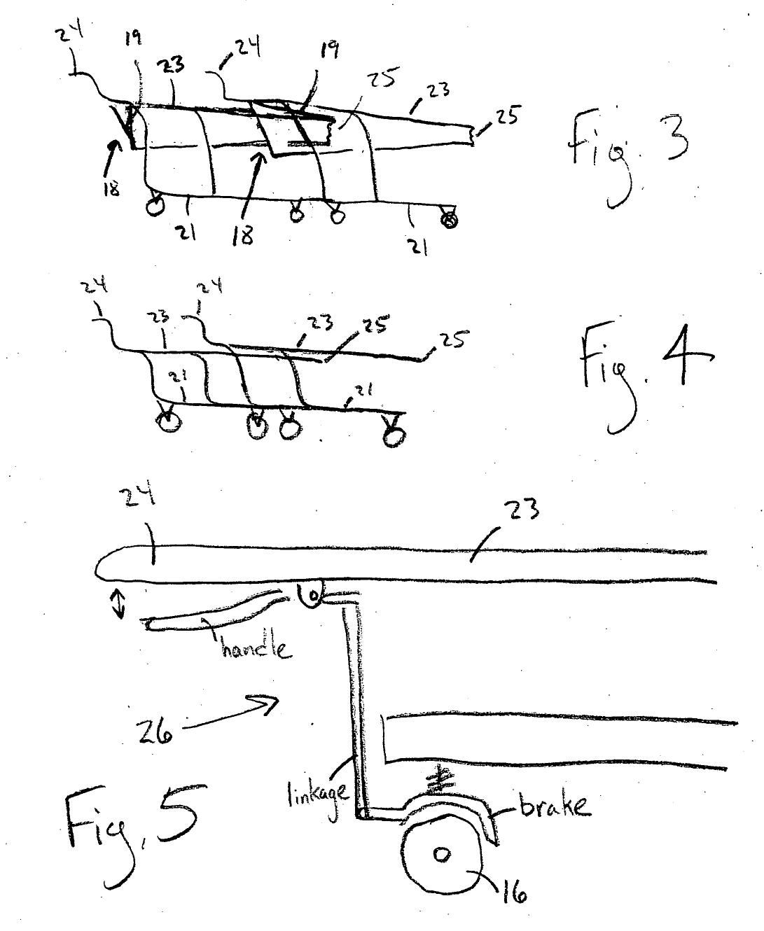

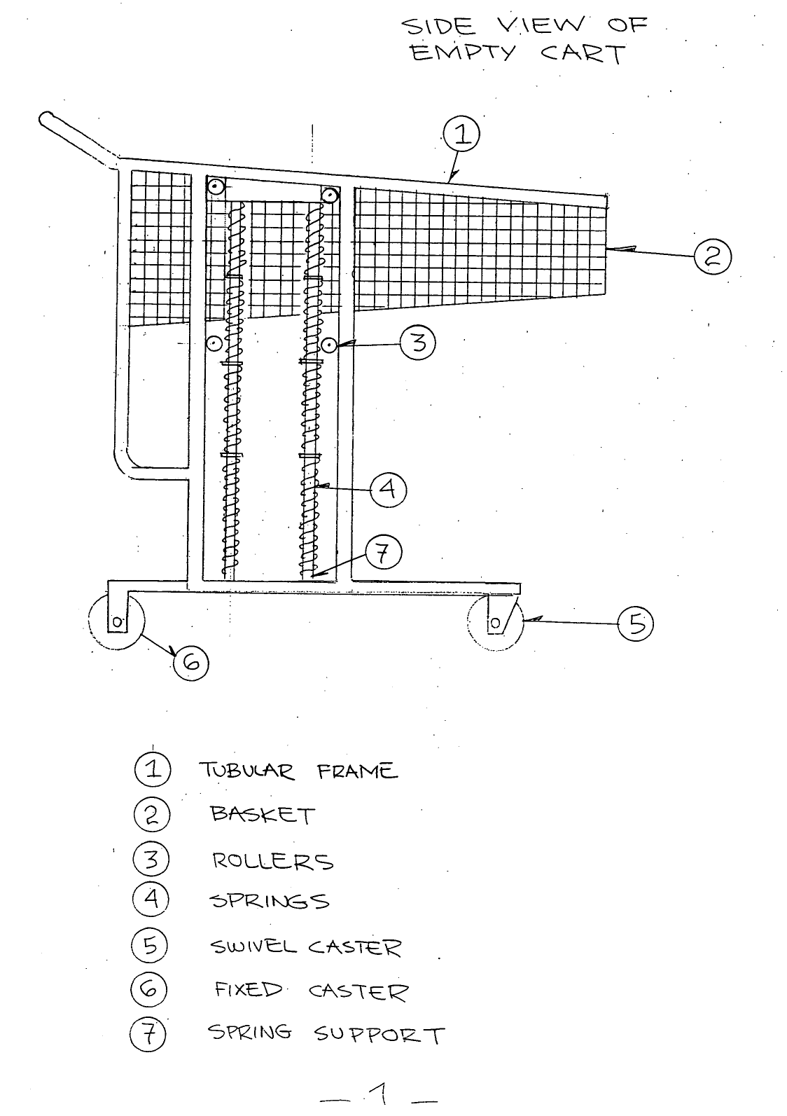

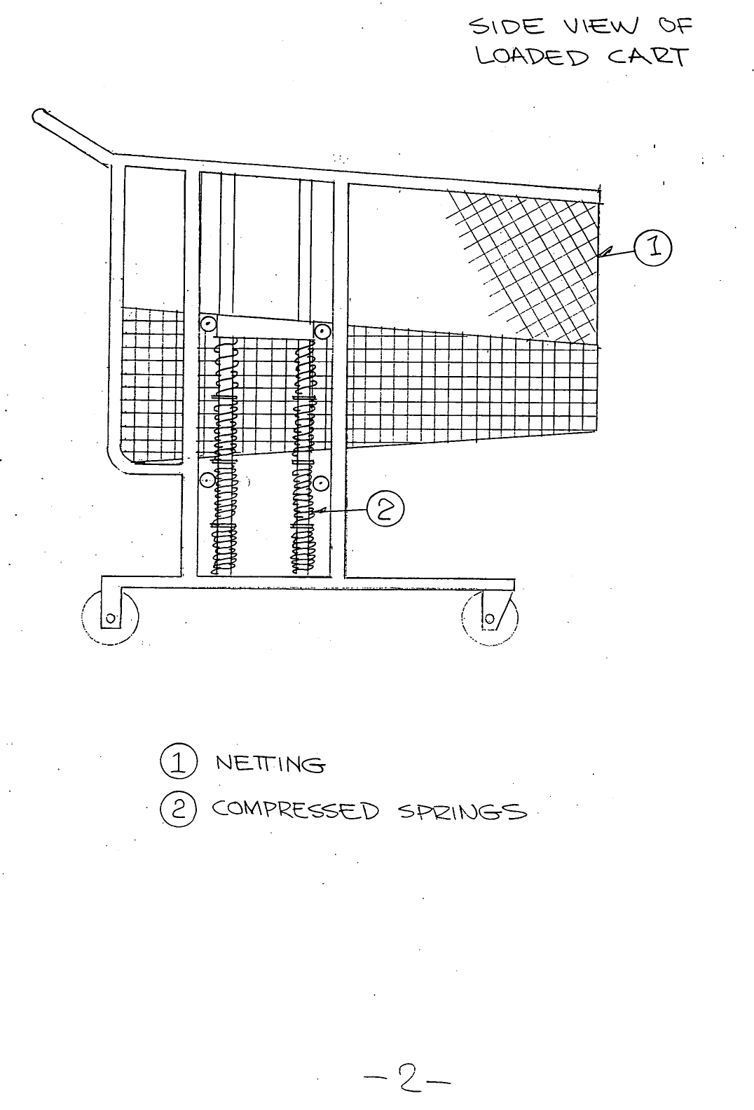

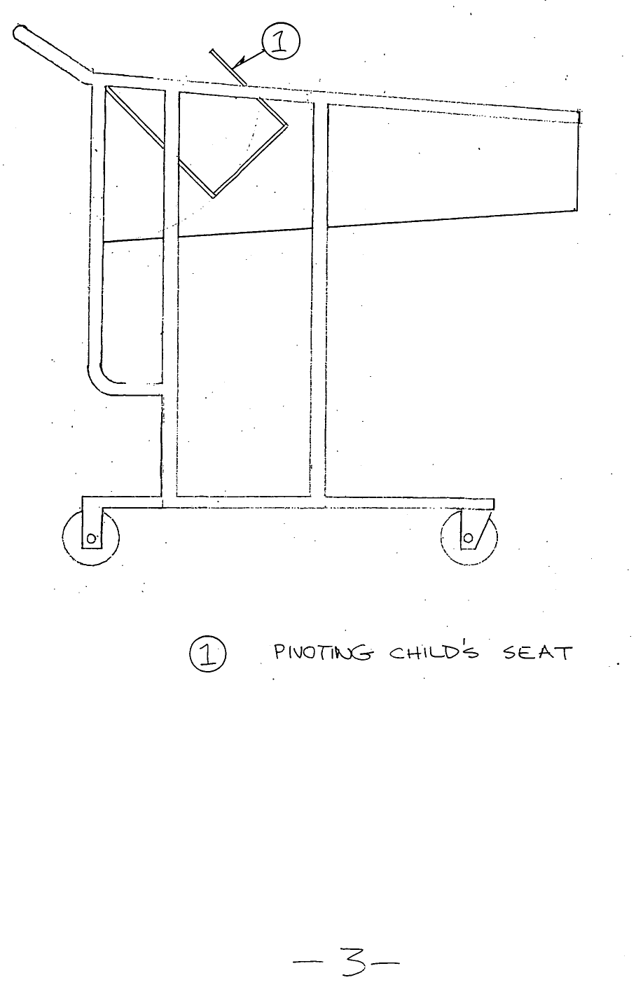

Referring to the figures, and. FIGS. 1 and 2 in particular, there is illustrated a shopping cart according to the present invention, generally indicated by reference numeral 1. Shopping cart 1 has many of the functional characteristics of conventional shopping carts in the sense that it is a wheeled container adapted to be manually propelled along the aisles of a store or market and have articles deposited therein. Shopping cart 1 departs in both specific structural and functional characteristics, however, and has many improvements and advantages.

Shopping cart 1 comprises a basket 10. In its fully extended configuration, basket 10 is of generally cuboid configuration with side walls 11 and 12; rear wall 13, front wall 14, bottom wall 15 and an open top. The walls 11, 12, 13, 14, and 15 define a volume that is expandable as bottom wall 15 is extended downwardly and that is reducible as bottom wall 15 is retracted upwardly. The open top is provided to permit items to be placed within basket 10.

Shopping cart basket 10 is attached to and supported by a frame 20. Frame 20′ comprises a lower substantially horizontally extended section 21 and an upper substantially horizontally extended section 23 spaced apart from one another by at least one substantially vertically extending elements 22a, 22b. As described in more detail hereinbelow, sections 21, 23, and/or elements 22a, 22b may be employed to guide the vertical displacement of bottom wall 15. Upper section 23 comprises a handle 24. Wheels 16 are preferably caster-type wheels, which are most commonly used type of wheel for shopping carts. Wheels 16 may be connected to section 23 by any type of axle.

Bottom wall 15 must be supported for movement between the retracted and extended positions by one or more support structures. Further, the particular support structure to be considered should be operative to urge the bottom wall 15 toward its retracted position, but permit displacements therefrom toward its extended position whenever loads of a sufficient magnitude are supported thereon. In this respect, the support structure employed includes a plurality of spaced apart support components. Each support structure may be functionally independent from the other support structure(s) or functionally dependent on one or more other support structures. For example, two support structures may be interconnected to resist asymmetrical displacement of bottom wall 15.

Support structures useful for the present invention include, but are not limited to, leaf springs, coil springs, air springs, progressive-rate springs, single-rate springs, torsion springs, pneumatic struts, hydraulic struts, natural resilient compounds like rubber, synthetic resilient compounds like urethane foam or EPS foam, or any other suitable construction and/or compound adapted to resist either compression or extension. Preferred support structures for the present invention are coil springs adapted to resist compression.

More preferably, shopping cart 1 comprises a first pair of spring assemblies 30a, 30b and a second pair of spring assemblies 40a, 40b. It is advantageous to employ at least two sets of springs, and even more advantageous to employ two set of springs with different maximum load capacities. Preferably, spring assemblies 30a, 30b have a first maximum load capacity, while spring assemblies 40a, 40b have a second maximum load capacity that is greater than the load capacity of spring assemblies 30a, 30b. The preferred maximum load capacity of spring assemblies 30a, 30b is about 15 lbs. The preferred maximum load capacity of spring assemblies 40a, 40b is about 25 lbs. The first pair of springs is connected at or adjacent to either the fore or aft corners of the bottom wall. Springs 40a, 40b are connected to respective side edges of bottom wall 15. The location of springs 40a, 40b depend on the purpose to which shopping cart 1 will be employed. For example, if shopping cart 1 is intended to typically carry very heavy loads, springs 40a, 40b should be positioned farther away from springs 30a, 30b.

Furthermore, each spring assembly may comprise a protective cover to enclose and protect the internally disposed spring(s). The protective cover may be a plurality of hollow telescopically related tubes. Alternatively, spring assemblies 30a, 30b, 40a, and 40b may be disposed within respective elements 22a, 22b, 22c, and 22d.

Preferably, low-friction, non-binding rollers are attached to the upper end of each spring. These rollers engage their respective guide posts 22a, 22b, 22c, 22d. These unique rollers allow bottom wall 15 to move with a cantilevered load without binding. As shown in the figures, the preferred rollers are nylon stepped rollers.

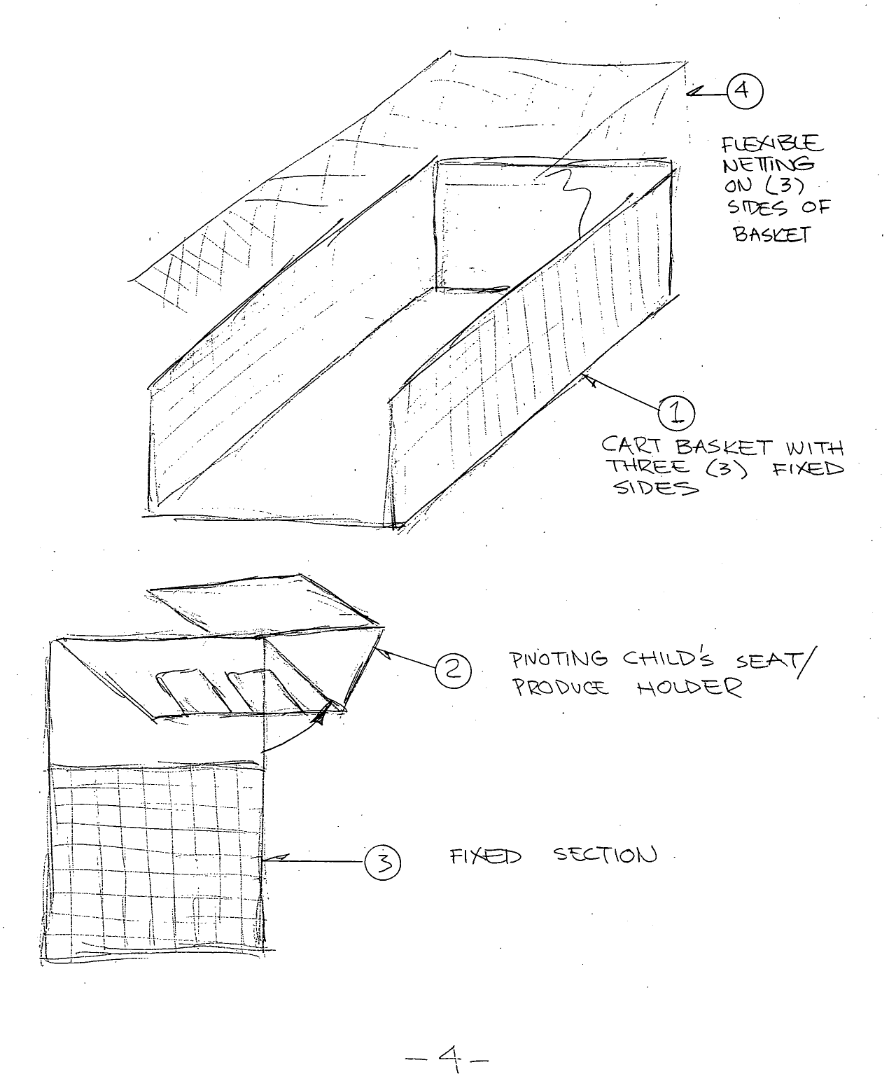

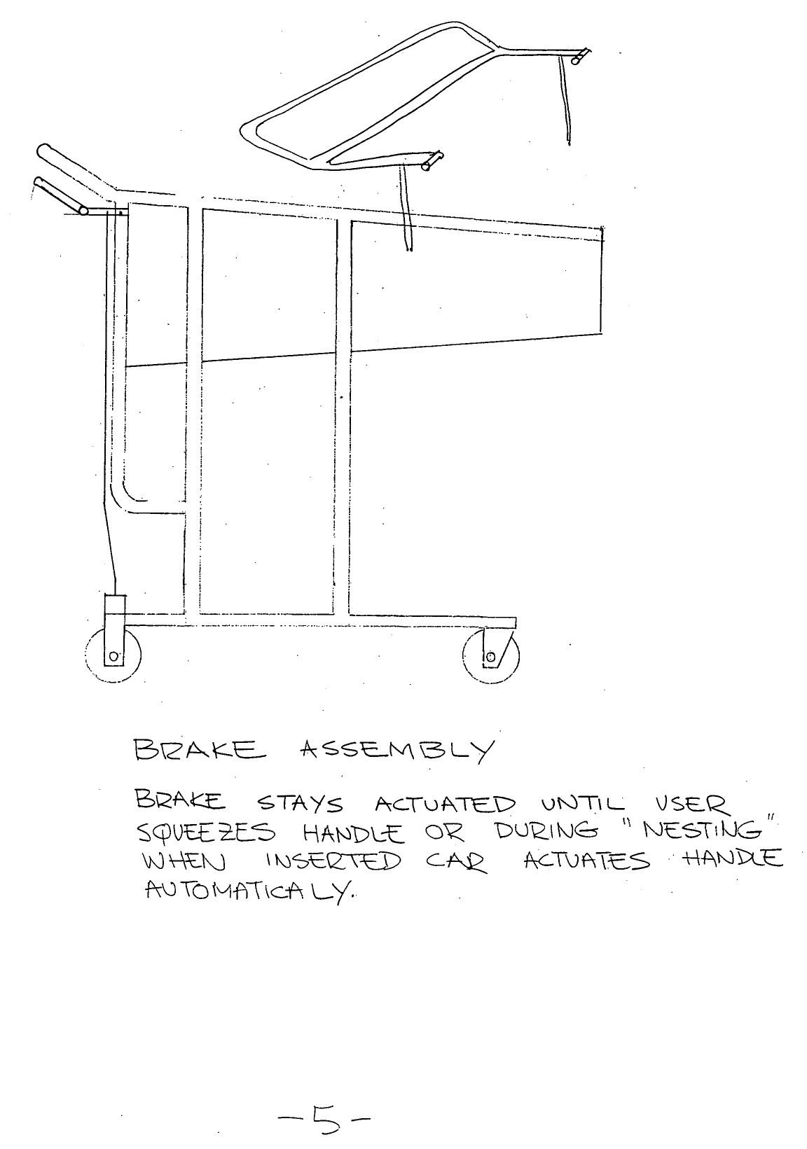

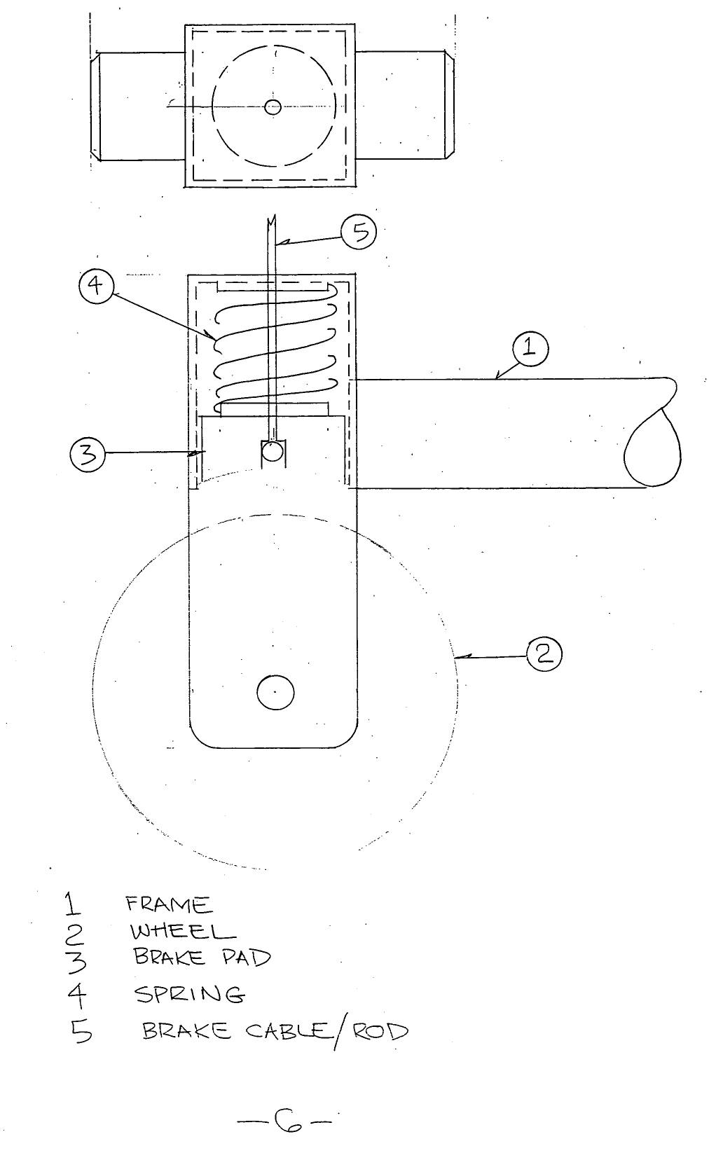

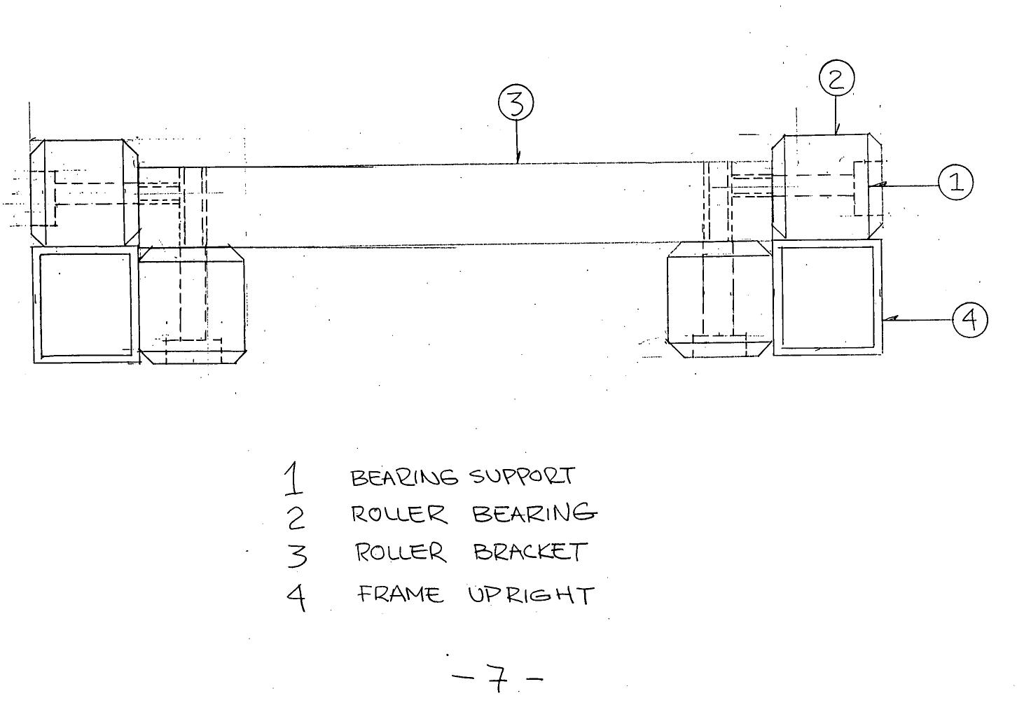

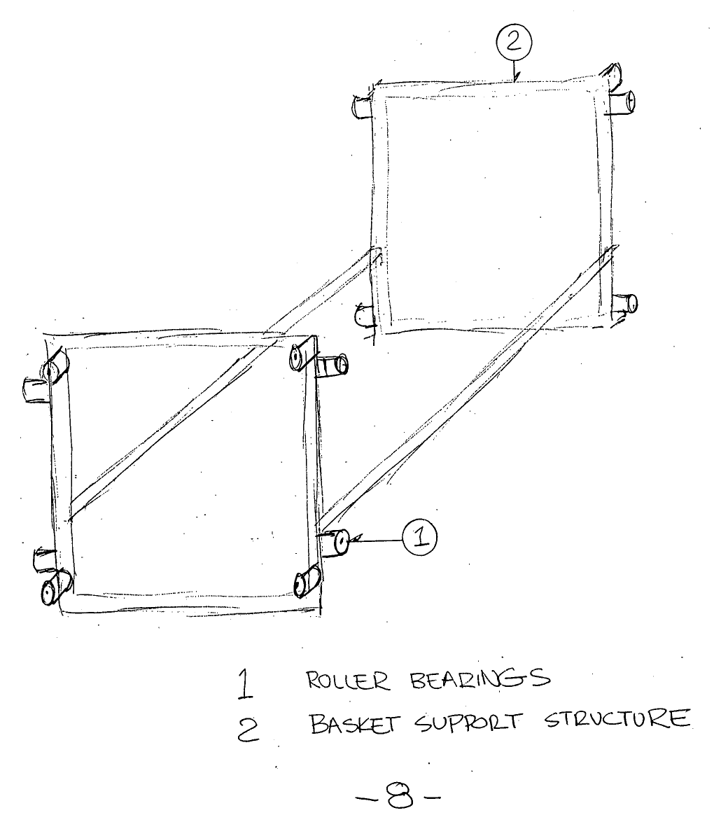

Referring to FIGS. 3 and 4, shopping cart 1 is preferably adapted to nest or interfit with other shopping carts of a similar configuration. Interfitting two or more shopping carts can be achieved using any suitable means. For example, as shown in FIG. 3, shopping cart basket 10 may comprises a rearward frame 18 defining an opening shielded by pivoting rigid gate or flap 19 through which the forward portion of another shopping cart may be inserted. Initially, flap 19 would close the slot in frame 18 to prevent contents inside basket 10 from falling therethrough, but flap 19 would yield to pressure from outside. Such a pivoting flap is common in shopping carts. Alternatively, as shown in FIG. 4, bottom wall 15 may be adapted to retract fully parallel with upper section 23 such that the space between lower section 21 and upper section 23 is essentially completely open. More specifically, by adapting upper section 23 with a slight slope or pitch from handle 24 downward to the front end 25, two shopping carts may be interfitted by sliding the upper section of one shopping cart beneath the upper section of the other shopping cart.

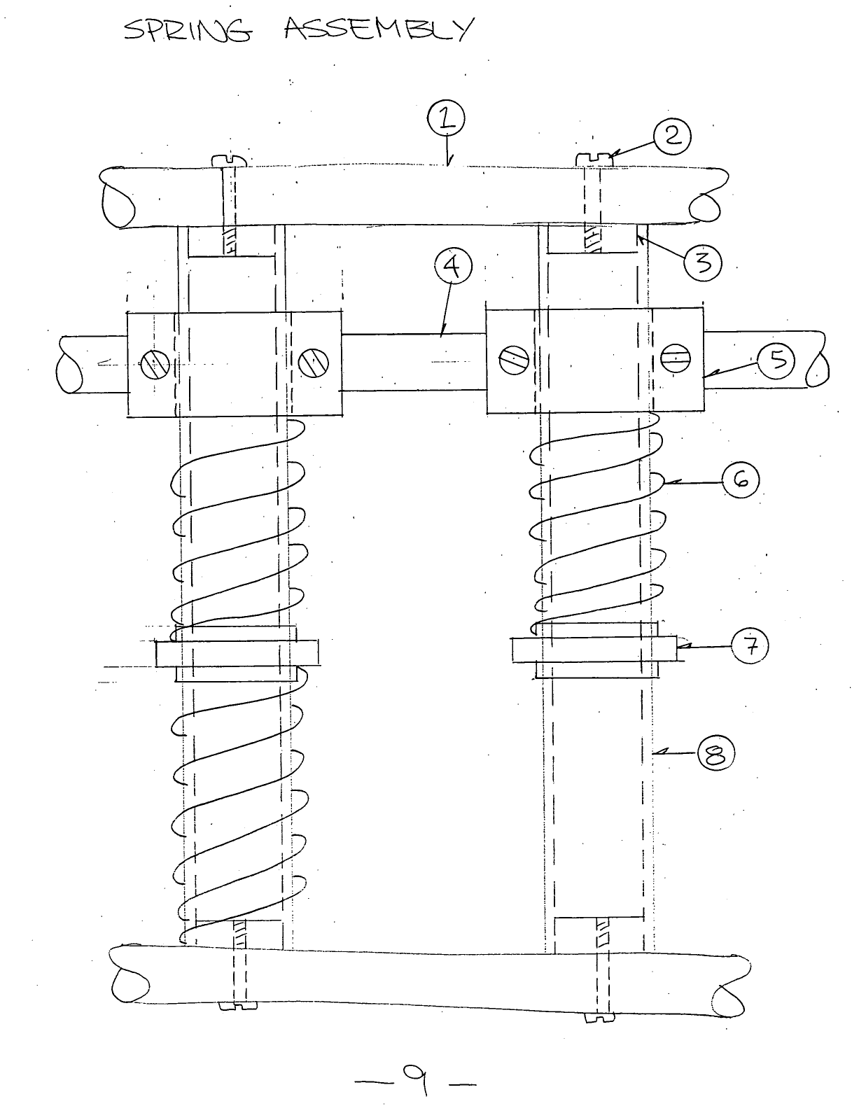

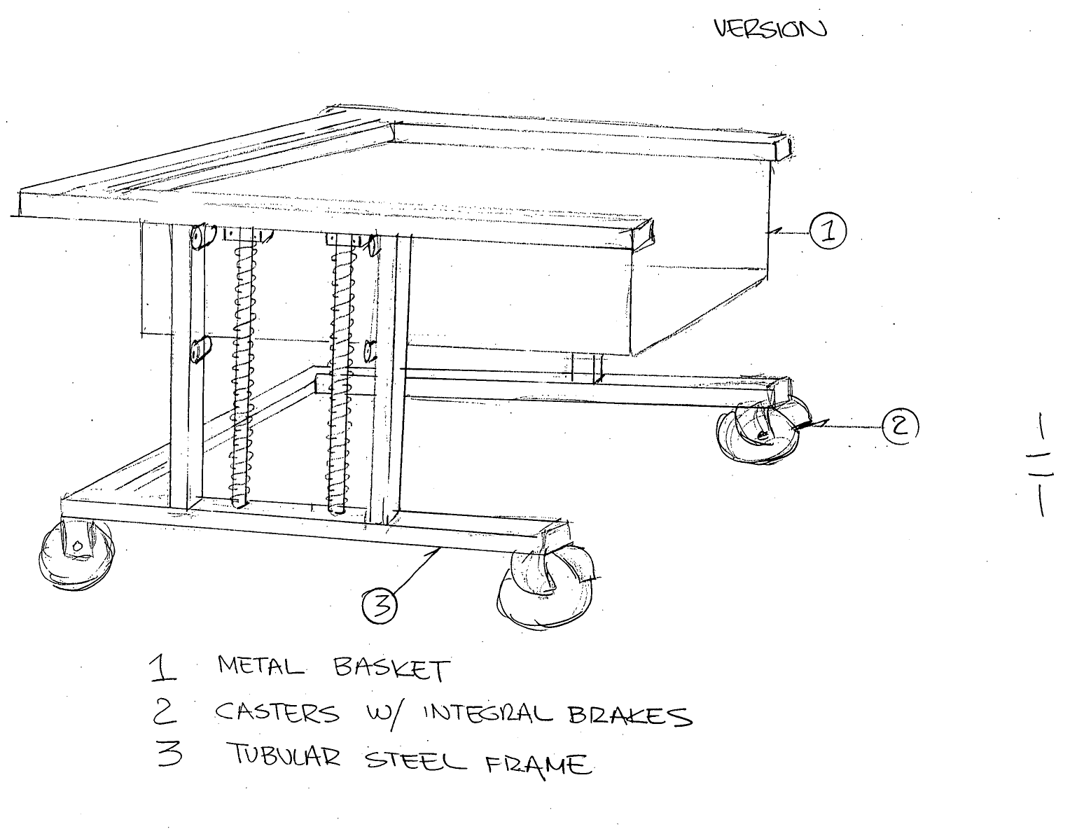

Referring to FIG. 5, shopping cart 1 preferably includes an automatic brake assembly 26 that locks at least one of the rear wheels of the cart against rotation. A brake handle disengages the brake assembly when the brake handle is moved toward the cart handle. In this manner, the brake assembly remains engaged until a user grasps the brake handle and shopping cart handle and pulls them together. The brake handle is preferably designed such that when multiple carts are nested together the brake handle engages the slanted upper portion of the frame and/or the slanted upper portion of the basket of the rearward adjacent cart to thereby push the brake handle toward the cart handle. In this manner, when multiple carts are nested together, the brakes of all but the rear cart are disengaged, thereby allowing the multiple nested carts to be moved to a desired location by grasping the cart handle and brake handle of the rear cart.

The shopping cart optionally includes a child seat. In the embodiment shown in the figures, the child seat comprises a flexible hammock supported by a bar. The bar may be moved from an open position as shown in FIG. to a closed position along slots provided at the top of the basket. The use of the flexible hammock child seat reduces the ability of a child riding in the seat to gain leverage and lift itself out of the seat. The child seat may optionally include a safety belt (not shown). For example, the safety belt may be generally Y shaped with two points of securement on the bar and one point of securement on the rear wall of the cart, between the child's legs. Although the child seat shown in the figures comprises a flexible hammock, any other suitable type of child seat may optionally be used.

Basket 10 may be constructed in the usual manner of a shopping cart comprising a plurality of vertical metal rods and horizontal metal cross-rods arranged in an intersecting arrangement, which constitutes an open cage-type construction. The rods and cross-rods are typically welded to one another at the various points of intersection. The strength and rigidity of the container depends upon the gauge and spacing of the rods and cross-rods. Concerning the spacing of the rods and cross-rods, the open spaces defined by the intersecting rods and cross-rods should be of a size that most items placed in the basket cannot fit through the open spaces and interfere with the lowering or raising of bottom wall 15.

Alternatively, basket 10 may be constructed with soft (i.e., fabric or non-metallic) side walls supported by one or more metal frames or sub-frames. In a preferred construction of basket 10, basket bottom wall 15 is of metal construction and is suspended from frame upper section 23 by flexible side walls of fabric mesh. The advantages of a non-metallic include the feature of eliminating the possibility of fingers or items being crushed by the collapsing side wall because, unlike metal rods, a non-metallic side wall will yield.

Frame 20 may be fabricated from any material usually used for this purpose, and in any conventional and convenient form. Frame 20 is preferably of hollow chrome plated steel tubes. In addition, the various elements of frame 20 may be secured one to another by any standard technique, such as welding, riveting, and/or pinning.

If desired a rack may be supported in the lower portion of frame 20. The rack may be loosely supported by frame lower portion 20 so as to permit the rack to be displaced upwardly whenever two carts 15 are stored in contiguous juxtaposition. The rack and frame lower portion 20 should be positioned relative to frame handle portion 22 such that a user may walk behind shopping cart 1 while holding frame handle portion 22 without stepping on or kicking either the rack or frame lower portion 20.

While the invention has been disclosed in preferred forms, it will be apparent to those skilled in the art that many modifications, additions, and deletions may be made therein without departing from the spirit and scope of the invention as set forth in the following claims.

1. A wheeled cart comprising:
a basket comprising a vertically moveable bottom wall;
a frame supporting the basket;
at least one support element attached to the moveable bottom wall and adapted to control the movement thereof;
whereby the vertically moveable bottom wall will move vertically downward when items are placed thereon.

2. (canceled)
